(19) United States
(12) Patent Application Publication
(10) Pub. No.: US 2026/0284820 A1
(43) Pub. Date: Sep. 24, 2026

(54) Bellows for Separating Two Spaces and a Machining Apparatus

(71) Applicant: vhf camfacture Aktiengesellschaft, Ammerbuch (DE)

(72) Inventor: Leonie Nora Partsch, Oberreichenbach (DE)

(73) Assignee: vhf camfacture Aktiengesellschaft, Ammerbuch (DE)

(21) Appl. No.: 19/570,566

(22) Filed: Mar. 18, 2026

(30) Foreign Application Priority Data
Mar. 19, 2025 (EP) 25164700.4

(51) Int. Cl. B23Q 11/08; F16J 15/52

(52) U.S. Cl. CPC B23Q 11/0816; F16J 15/52

(57) ABSTRACT

A bellows (10) for separating two spaces, in particular in a machining apparatus (1), in particular in a dental machining apparatus, includes a membrane (11) and an elastic tensioner (20) formed separately from the membrane (11). The membrane (11) is deformable in at least two dimensions. The bellows (10) includes a receptacle (14) for attaching the membrane (11) to a movable component, in particular of the machining apparatus (1). The elastic tensioner (20) is operatively connected to the membrane (11) in such a way that the membrane (11) is gathered by the elastic tensioner (20).

### CROSS-REFERENCE TO RELATED APPLICATION

This application claims the benefit of European Patent Application EP 25164700.4, filed on Mar. 19, 2025, the contents of which is incorporated by reference in its entirety.

### TECHNICAL FIELD

The disclosure relates to a bellows for separating two spaces, in particular in a machining apparatus, in particular in a dental machining apparatus. Furthermore, the disclosure relates to a machining apparatus, in particular a dental machining apparatus.

### BACKGROUND

The prior art discloses a machining apparatus, in particular a dental machining apparatus, of which the drive unit is separated from the processing chamber by a bellows. The separation of the processing chamber and the drive technology is necessary, as otherwise the drive technology would become contaminated by, for example, swarf, coolant and the like. As the tool is in constant motion within the processing chamber, the spatial separation of the processing chamber and the drive mechanism is difficult. It is known that bellows are used for this purpose, which are typically designed as rubber bellows or lamellar bellows.

Rubber bellows may have a comparatively limited service life. Due to the constant movement of the rubber bellows during processing operations, it is subjected to high stress, which can lead to cracks in the rubber bellows after a considerable period of time. Replacement of the rubber bellows is then necessary. To allow sufficient freedom of movement, a rubber bellows requires material having dimensions that are larger than the travel range to be accommodated. The material of the rubber bellows is deformed accordingly during the tool's travel movements. When the rubber bellows folds, the folded material takes up a lot of space, which must be provided within the machining apparatus. If the material does not fold as intended, a collision between the rubber bellows and parts of the machining apparatus may even occur.

Lamellar bellows may have a limited range of motion. If the tool moves in multiple dimensions, several lamellar bellows are required. Guiding these multiple lamellar bellows is complex and therefore costly. Furthermore, a lamellar bellows may not provide complete sealing against dust or liquids. If such sealing is required, the lamellar bellows must be combined with additional systems.

### SUMMARY

One object of the disclosure is to provide a bellows that is durable, inexpensive and versatile. This object is solved by a bellows as disclosed herein.

The bellows is suitable to separate two spaces. The two spaces may, in particular, be provided in a machining apparatus, specifically in a dental machining apparatus. Alternatively, it may also be provided that one of the two spaces is assigned to a machine, while the other of the two spaces is the machine environment. A machine may, for example, be a machining apparatus, a robot or a similar machine. The bellows comprises a membrane and an elastic tensioner formed separately from the membrane. The membrane is deformable in at least two dimensions. The bellows has a receptacle for attaching the membrane to a movable component, in particular of the machining apparatus. The elastic tensioner is functionally connected to the membrane in such a way that the membrane is gathered by the elastic tensioner.

A “membrane” within the meaning of the present disclosure is a thin separating layer configured to separate two spaces.

The disclosure is based on the realisation that the increased wear of the rubber bellows is in essence attributable to its dimensional rigidity. While this maintains the rubber bellows in its shape, it can lead to high stresses within the bellows when the rubber bellows moves. Consequently, cracks may appear in the rubber bellows at an early stage.

The improved bellows is now designed such that the separation of the two chambers is effected by a membrane, while the gathering of the membrane is provided by an elastic tensioner. Thus, the functions of separation and dimensional rigidity are distributed across different components. The membrane itself therefore no longer needs to be dimensionally rigid, but is held in shape by the tensioner. The load on the membrane is significantly lower, thereby preventing high stresses in the membrane and thus also the early occurrence of cracks.

The membrane is deformable in at least multiple spatial directions and can therefore also move in at least two spatial directions. Preferably, the membrane is deformable in three, particularly in five, and most particularly in six degrees of freedom. Consequently, the bellows with its membrane can be used in any standard machining apparatus. The use of multiple bellows in a single machine, as in a lamellar bellows, is therefore no longer necessary.

It is particularly envisaged that the membrane comprises at least a first membrane layer, wherein the first membrane layer is in particular formed from a sheet material, in particular a textile sheet material or a film. Such sheet material has only low or no dimensional rigidity. The stresses occurring in the sheet material during its deformation are therefore very low. In the preferred embodiment, the sheet material is not dimensionally rigid, so that no stresses occur during its deformation. Preferably, the membrane comprises at least a second membrane layer, wherein the second membrane layer is formed in particular from a sheet material, in particular a textile sheet material or a film. The membrane may also comprise more than two membrane layers. The multiple membrane layers may, in particular, have different sizes. The multiple membrane layers may, in particular, be formed from different materials. A combination of textile sheet material and a film may also be suitable as a membrane. Advantageously, the textile sheet material has a coating.

It is preferably provided that the at least one first membrane layer and/or the at least one second membrane layer is shaped like a truncated pyramid or a truncated cone. Other geometries of the membrane, for example a combination of a truncated pyramid and a truncated cone, may also be suitable.

In particular, it is provided that the membrane comprises a holding unit by means of which the elastic tensioner is held on the first membrane layer and/or the second membrane layer. The holding unit may be arranged on the first membrane layer and/or the second membrane layer, and in particular may be formed there. The holding unit may also be formed by the first membrane layer and the second membrane layer. In an alternative embodiment of the bellows, the elastic tensioner may also be held directly in a membrane layer. In such an embodiment, a holding unit for the elastic tensioner would not be necessary. A combination, namely that the elastic tensioner is held at least partially via the holding unit and at least partially directly on the first membrane layer and/or at least partially on the second membrane layer, may also be appropriate.

It is advantageously provided that the holding unit is a casing. The casing is formed in particular by a connection between the first membrane layer and the second membrane layer. The connection is formed in particular as a seam. Alternatively, the connection may also be formed by bonding, welding, riveting or a similar connection. Preferably, the tensioner is held movably within the casing. In this way, the deformation of the tensioner is distributed over its entire length. The tensioner can, in particular, be moved within the casing. Localised overloading of the tensioner can thus be avoided. This enhances the service life of the tensioner.

The casing has, in particular, meandering paths. Due to the formation of the meandering paths, the casing runs in several spatial directions, preferably in three spatial directions. The tensioner consequently also runs in several, in particular three, spatial directions, whereby the gathering of the membrane also acts in several spatial directions, in particular three spatial directions. Here, various patterns may be appropriate due to the formation of the meandering paths. The meandering paths are preferably formed such that, when the membrane is stretched, they extend in at least two, in particular three, spatial directions. Thus, effective gathering of the membrane can be achieved, thereby saving installation space.

In particular, it is provided that the elastic tensioner is a rubber band, in particular a single rubber band, wherein the rubber band is held in the casing so as to be slidable, in particular fully slidable. The deformation of the rubber band can thus be distributed across the entire rubber band. Preferably, the rubber band is knotted together at both ends. Alternatively, the rubber band may also be attached at its ends to the membrane itself or connected to itself in some other way, for example by adhesive bonding. In this case, at least the full slidability of the rubber band within the casing is no longer guaranteed.

The rubber band comprises, in particular, an elastic core and a sheath surrounding the elastic core, wherein the sheath is designed to provide overload protection for the elastic core and to allow it to slide over the holding unit, over the at least one first membrane layer and/or over the at least one second membrane layer. The overload protection prevents the elastic core from overstretching and/or tearing. The sheath therefore fulfils several functions. Both the overload protection and the improvement in sliding properties have a beneficial effect on the service life of the rubber band and thus on the service life of the bellows. Furthermore, the sheath prevents abrasion damage to the elastic core that could occur due to relative movements with respect to the membrane.

The receptacle of the bellows is preferably cup-shaped. The receptacle in turn surrounds the tool holder, for example of a machining apparatus. The receptacle of the bellows is made, in particular, from a dimensionally stable material. The receptacle comprises, in particular, an opening. The receptacle can then be easily attached to the tool holder, in particular by being fitted onto the tool holder. The tool holder protrudes through the opening in the receptacle of the bellows.

A further object of the disclosure is to provide a machining apparatus that is cost-effective and low-maintenance. This object is solved by a machining apparatus as disclosed hereafter.

The machining apparatus, in particular a dental machining apparatus, comprises a tool holder for holding a tool, wherein the tool is intended for additive and/or subtractive processing of a workpiece, a drive chamber with a drive unit for moving the tool holder and/or for moving the tool, a processing chamber in which the workpiece is processed, and a bellows, wherein the bellows separates the drive chamber and the processing chamber from one another. The bellows comprises a membrane and an elastic tensioner formed separately from the membrane. The membrane is deformable in at least two dimensions. The bellows has a receptacle for attaching the membrane to a movable component of the machining apparatus. The elastic tensioner is functionally connected to the membrane in such a way that the membrane is gathered by the elastic tensioner.

### BRIEF DESCRIPTION OF THE DRAWINGS

FIG. 1 is a schematic, perspective view of a machining apparatus,

FIG. 2 is a schematic, perspective view of the interior of a machining apparatus with a bellows,

FIG. 3 is a schematic sectional view of the bellows connected to the machining apparatus,

FIGS. 4a and 4b show, in a schematic, partial sectional view, the connections of the bellows to the machining apparatus,

FIG. 5 shows, in a schematic, partial cross-sectional view, a further embodiment of the connections of the bellows to the machining apparatus,

FIG. 6a to 6c show, in various views, an embodiment of the bellows,

FIG. 7 shows, in a perspective sectional view, the bellows with a rubber band,

FIG. 8a to 8c show, in various views, a further embodiment of the bellows, and

FIG. 9a to 9c show, in various views, a further embodiment of the bellows.

### DETAILED DESCRIPTION

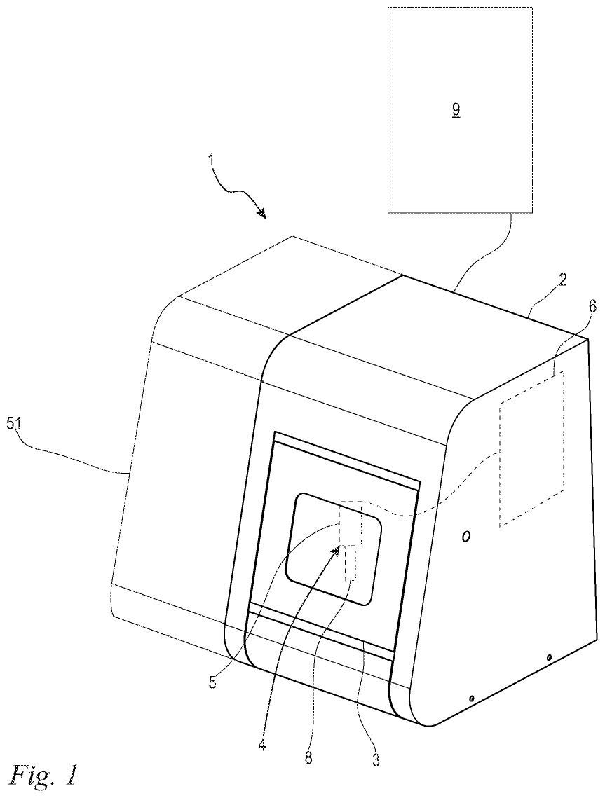

FIG. 1 shows a perspective view of a machining apparatus 1, in particular a dental machining apparatus, which in the exemplary embodiment is designed as a dental milling machine. The machining apparatus 1 is intended for the manufacture of dental prostheses, in particular for the production of dental crowns, bridges or similar dental prostheses. The machining apparatus 1 comprises a housing 2 which defines an interior space of the machining apparatus 1. A loading door 3 is arranged on the housing 2 of the machining apparatus 1. The loading door 3 can be used to open or close an opening in the housing 2. After opening the loading door 3, access to the interior of the machining apparatus 1 is open, for example to insert or remove a workpiece 50. A spindle unit 4 is arranged within the machining apparatus 1, wherein, in the preferred embodiment, the spindle unit 4 is adjustable both translationally and rotationally in space via a drive unit not shown in detail. In the present embodiment, the machining apparatus 1 is specifically designed such that it can perform 5-axis simultaneous processing. In an alternative exemplary embodiment, the drive unit may also be configured such that the spindle unit 4 is adjustable only in a translational or rotational manner.

The machining apparatus 1 comprises a control unit 6 shown schematically in FIG. 1. The spindle unit 4 shown in FIG. 1 comprises a spindle 8 and an electric motor 5. The electric motor 5 is connected to the control unit 6 via an electrical connection of the spindle unit 4. The control unit 6 serves, among other things, to supply power to and control the spindle unit 4 as well as the drive unit.

The dental machining apparatus 1 comprises a workpiece holder, not shown in detail, in which the workpiece 50 is fixed, in particular clamped.

As shown in FIG. 1, in the exemplary embodiment, the machining apparatus 1 is coupled to a computer unit 9. The computer unit 9 preferably comprises a CAD system on which a dental prosthesis is modelled. The computer unit 9 comprises, in particular, a CAM system on which NC programming can be carried out. The NC programming is used to define various parameters of the mechanical processing by means of the dental machining apparatus 1. Once the NC programming is complete, it is transferred to the control unit 6. Naturally, the CAD system and the CAM system may be a single system, in particular a software programme.

As shown in FIG. 1, the preferred embodiment of the machining apparatus 1 comprises a workpiece changer 51 in which several workpieces 50 or blanks can be stored. To process a blank, the workpiece holder accesses the workpiece changer 51 and removes a suitable blank. In an alternative embodiment, the machining apparatus 1 may also be designed without a workpiece changer 51, in which case manual insertion or removal of the blank is required.

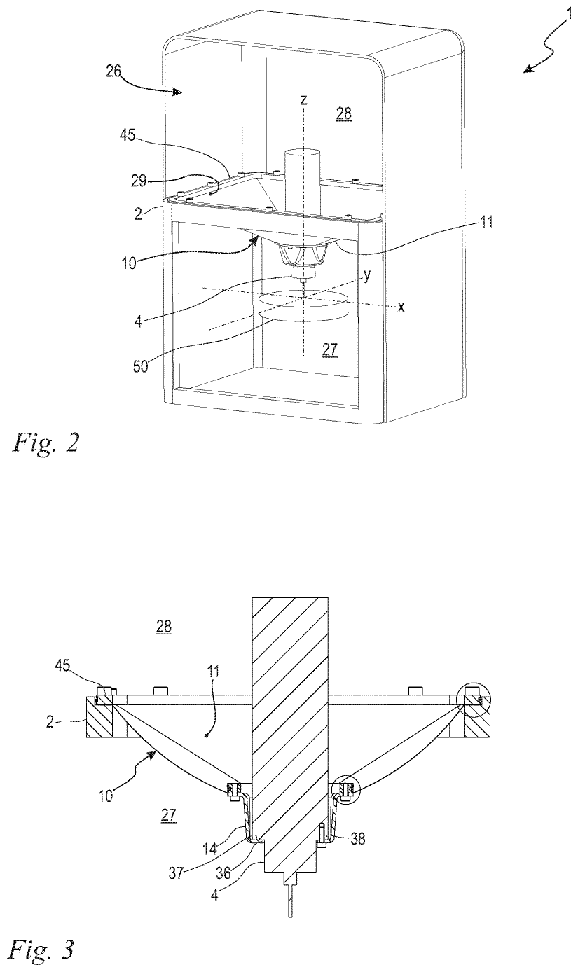

FIG. 2 shows a schematic representation of an interior 26 of the machining apparatus 1. As shown in FIG. 2, the machining apparatus 1 comprises a bellows 10. The bellows 10 is designed to separate two chambers. In the present embodiment of the machining apparatus 1, the two chambers are a processing chamber 27 and a drive chamber 28. The workpiece 50 is processed in the processing chamber 27. The drive unit, which is not shown in detail, is arranged in the drive chamber 28. The processing chamber 27 of the machining apparatus 1 and the drive chamber 28 of the machining apparatus 1 are separated from one another by the bellows 10. The drive unit located in the drive chamber 28, as well as any associated electronics, are protected by the bellows 10 from dirt particles generated in the processing chamber 27, such as swarf or grinding dust.

As shown in FIG. 2, the spindle unit 4 protrudes through the bellows 10. The bellows 10 is connected to the spindle unit 4 in such a way that, even when the spindle unit 4 moves, the processing chamber 27 and the drive chamber 28 remain separated from one another by the bellows 10. To this end, the bellows 10 is designed to be deformable.

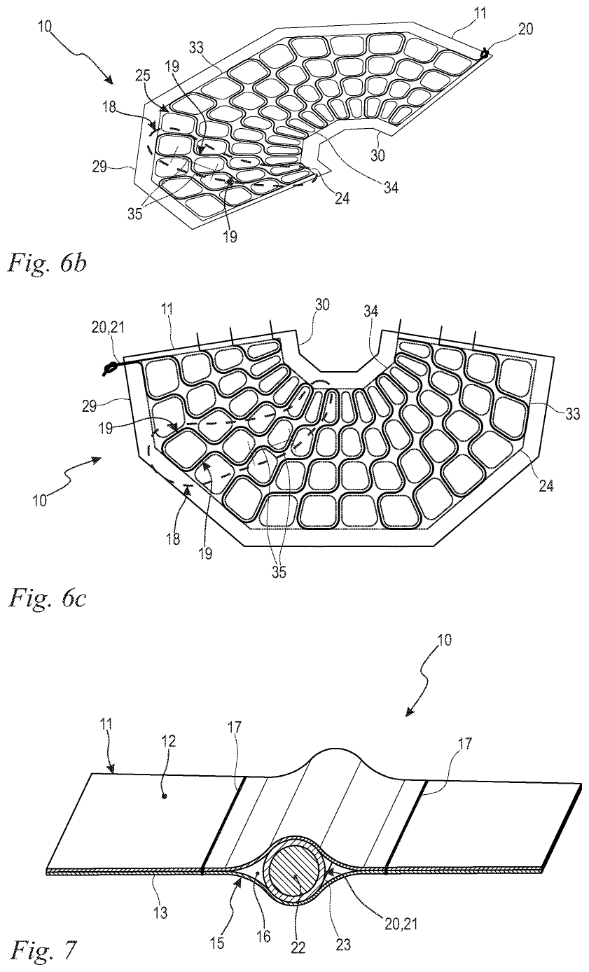

FIGS. 6a to 6c schematically show an exemplary embodiment of the bellows 10. As shown in FIG. 6a, the bellows 10 has a three-dimensional body. In this embodiment, the bellows 10 is shaped like a pyramid. The bellows 10 corresponds merely to the lateral surface of a pyramid. FIGS. 6b and 6c show the bellows 10 in its unfolded state.

As shown in FIG. 6a, the bellows 10 extends from a first end 29 to a second end 30. At its first end 29, the bellows 10 on the machining apparatus 1 is fixedly attached to the housing 2 of the machining apparatus 1. At its second end 30, the bellows 10 is secured to the movable component, in this case the spindle unit 4, of the machining apparatus 1. The bellows 10 comprises, in particular, a through-opening 31, which is formed, in particular, at the second end 30 of the bellows 10. The movable component, in particular the spindle unit 4, protrudes through the through-opening 31. The movable component, in particular the spindle unit 4, protrudes from one chamber, in particular the drive chamber 28, through the through-opening 31 into the other chamber, in particular into the processing chamber 27. In the present embodiment of the bellows, the first end 29 of the bellows 10 corresponds to the end of the lateral surface that abuts a base area of the pyramid. The second end 30 of the bellows 10 corresponds to the end of the lateral surface that abuts a top area of the pyramid.

As shown in FIGS. 6a to 6c, the bellows 10 comprises a membrane 11. The ‘membrane’ is a thin separating layer which possesses the ability to separate two spaces. In the present case, the membrane 11 is specifically designed such that it is impermeable to dirt particles, such as chips and grinding dust. The machining apparatus 1 may also be designed such that wet processing can be carried out. In such an embodiment, the membrane 11 is, in particular, impermeable to liquids such as water, coolant or similar liquids. This ensures that no liquids enter the drive chamber 28 and damage the drive unit and electronics.

The membrane 11 is, in particular, deformable in at least two spatial directions, or degrees of freedom. It is particularly advantageous for the membrane 11 to be deformable in at least three degrees of freedom. In the present embodiment, the membrane 11 of the bellows 10 is deformable in six degrees of freedom. Thus, the membrane 11 can be deformed translationally in all spatial directions, as well as rotated, without being damaged in the process.

As shown in FIGS. 6b and 6c, the bellows 10 comprises an elastic tensioner 20. The elastic tensioner 20 is formed separately from the membrane 11. The elastic tensioner 20 is operatively connected to the membrane 11 in such a way that the membrane 11 is gathered by the elastic tensioner 20.

FIG. 7 shows a schematic cross-section of the bellows 10, in which the membrane 11 and the elastic tensioner 20 are depicted. The membrane 11 comprises at least a first membrane layer 12. The first membrane layer 12 is formed, in particular, from a sheet material. In the present embodiment of the bellows 10, the membrane 11 comprises, in addition to the first membrane layer 12, a second membrane layer 13. The second membrane layer 13 is formed in particular from a flat material. In an alternative embodiment of the bellows 10, it may also be provided that the membrane 11 has more than two membrane layers.

The first membrane layer 12 is formed in particular from a textile fabric, for example a woven fabric, in particular a ripstop fabric, a weft-knitted fabric, a warp-knitted fabric or the like. The choice of textile fabric has a particular effect on flexibility, durability, and sealing properties. Naturally, properties such as the elasticity and permeability of the textile fabric are influenced by further parameters, such as material, mesh size or yarn strength. Alternatively, the first membrane layer 12 may also be formed as a film.

The second membrane layer 13 is formed in particular from a textile sheet material, for example a woven fabric, in particular a ripstop fabric, a weft-knitted fabric, a warp-knitted fabric or the like. Alternatively, the second membrane layer 13 may also be formed as a film. Further membrane layers may also be formed from various sheet materials in a manner analogous to the first membrane layer and/or the second membrane layer. The first membrane layer 12 and the second membrane layer 13 of the membrane 11 may consist of the same sheet material. The first membrane layer 12 and the second membrane layer 13 of the membrane 11 may be formed from different sheet materials. For example, the first membrane layer 12 may be formed from a textile sheet material and the second membrane layer 13 from a film for sealing against liquids. The first membrane layer 12 and the second membrane layer 13 may, in particular, have the same or different dimensions. It may, for example, be provided that several second membrane layers 13, separated from one another, are provided on a single first membrane layer 12.

Preferably, the membrane 11 is provided with a coating. The coating is, in particular, formed such that it promotes, for example, the wear resistance of the one and/or the several membrane layers 12, 13. Furthermore, such a coating may reduce flammability and/or have an antistatic effect. The coating may also be designed to increase the impermeability of the membrane 11. For example, a coating providing impermeability to a liquid may be provided on the membrane 11. In such a configuration, the coating is preferably formed on the side of the membrane 11 facing the processing chamber 27. The coating may also be designed such that the membrane 11 is impermeable to dust particles or air. The coating may also be designed to protect the membrane 11 against environmental influences. Such environmental influences may, for example, be UV light, heat or moisture.

As shown in FIG. 7, the bellows 10 comprises the elastic tensioner 20. The elastic tensioner 20 is arranged on the membrane 11 and operatively connected thereto in such a way that the membrane 11 is gathered by the elastic tensioner 20.

In the present embodiment, the bellows 10 comprises a holding unit 15 via which the elastic tensioner 20 is held on the membrane 11. The holding unit 15 corresponds in this case to a casing 16 in which the elastic tensioner 20 is arranged, and in particular guided. The casing 16 is formed from the first membrane layer 12 and the second membrane layer 13, as well as from their connection 17. The connection 17 between the first membrane layer 12 and the second membrane layer 13 is preferably formed by a seam. Alternatively, the connection 17 may also be formed by bonding, welding, riveting or a similar connection.

Preferably, the elastic tensioner 20 is arranged so as to slide completely within the holding unit 15, in particular within the casing 16. The elastic tensioner 20 can thus move relative to the membrane 11 along the holding unit 15. Alternatively, the elastic tensioner 20 may also be fixed at one or more points along the holding unit 15, in particular along the casing 16, so that relative movement between the elastic tensioner 20 and the membrane 11 is prevented at least at the fixing points.

The elastic tensioner 20 is preferably at least one rubber band 21. The rubber band 21 is preferably held within the casing, in particular so as to be fully slidable. As shown in particular in FIGS. 6b and 6c, the elastic tensioner 20 is in particular formed from a single rubber band 21. The rubber band 21 is preferably knotted together at its ends. Alternatively, the rubber band 21 may also be secured at its ends to the membrane 11 or to itself. In an alternative embodiment, it may also be provided that the elastic tensioner 20 is formed from a plurality of rubber bands 21.

As shown in FIG. 7, the rubber band 21 comprises an elastic core 22 and a sheath 23 surrounding the elastic core 22. The sheath 23 is designed to provide overload protection for the elastic core 22. This prevents the elastic core 22 from being overstretched and/or tearing. At the same time, the sheath 23 is designed to slide over the holding unit 15 and/or the membrane 11. Furthermore, the sheath 23 serves as abrasion protection for the elastic core 22.

FIGS. 6a, 8a and 9a show embodiments of the membrane 11 of the bellows 10, in which the membrane 11 has the shape of a truncated pyramid. In deviation from a classic pyramidal shape, the ends 29, 30 of the membrane 11 may have a triangular shape instead of a quadrilateral shape. Thus, the base area and top area enclosed by the lateral surface of the membrane 11 would be quadrilateral and triangular, respectively. A different number of corners is also conceivable. In an alternative embodiment, the membrane 11 has the shape of a truncated cone. The ends 29, 30 of the membrane 11 may have an elliptical shape instead of a circular one. Consequently, the base area and top area enclosed by the lateral surface of the membrane 11 would be circular and elliptical, respectively. It may also be provided that the membrane 11 is partly pyramid-shaped and partly cone-shaped. For example, one of the two ends 29, 30 of the membrane 11 may be angular and the other of the two ends 29, 30 may be round or elliptical. The shape of the membrane 11 is preferably three-dimensional. The specific design of the shape of the membrane 11 may preferably also be based on the design of the machining apparatus 1 and its connection points for the bellows 10.

As shown in FIG. 7, the holding unit 15 is preferably designed as a casing 16. In an alternative embodiment, it may also be provided that the holding unit 15 is formed as an arrangement of several eyelets, loops or the like, in which the elastic tensioner 20 is held on the membrane 11. The aforementioned embodiments of the holding unit 15 can, of course, be combined with one another. The arrangement of the multiple eyelets, loops or the like is secured to the membrane 11, in particular to the first membrane layer 12. If the membrane 11 comprises a plurality of membrane layers 12, 13, the arrangement of the plurality of eyelets, loops or the like may be provided on one of the plurality of membrane layers 12, 13 or on a plurality of membrane layers 12, 13.

Alternatively, the elastic tensioner 20 may also be held directly within the membrane 11, in particular within a membrane layer 12 of the membrane 11. If, for example, a membrane layer 12 is formed as a knitted fabric, the elastic tensioner 20 may be guided within the knitted fabric. In this case, no separate holding unit 15 is required.

The casing 16 shown in FIG. 7 is formed by the first membrane layer 12, the second membrane layer 13 and their connection 17. The casing 16 may, in particular, also be formed on only one membrane layer 12, 13. Such a design is preferred if the membrane 11 comprises only a single membrane layer in any case. However, the casing 16 formed on only one membrane layer 12, 13 may also be suitable where the membrane 11 comprises several membrane layers 12, 13, for example a textile sheet material combined with a film. The casing 16 may, in particular, consist of several sections. The several sections may be connected to one another or may be formed separately from one another.

As described above, the membrane 11 of the bellows 10, as also shown in FIGS. 6a, 8a and 9a, preferably takes the form of a three-dimensional body. The elastic tensioner 20 and, in particular, the holding unit 15 are designed such that the membrane 11 is gathered in a three-dimensional manner. Depending on the position of the movable component of the machining apparatus 1, in this case the spindle unit 4, to which the membrane 11 is attached, the membrane unfolds in certain sections. In other sections, excess membrane material is created. This excess membrane material is gathered by the elastic tensioner 20. The three-dimensional gathering prevents excess membrane sections from protruding into the processing chamber 27 and/or the drive chamber 28 and colliding with the workpiece or components of the machining apparatus 1.

To create a three-dimensional gathering, the elastic tensioner 20 is guided in three-dimensions along the membrane 11 by the holding unit 15. For better understanding, FIG. 2 shows a machine coordinate system, which is reproduced in the same form in FIG. 6a. The membrane 11 shown in FIG. 6a is in an unpleated state. The bellows 10 comprises a guide 25 for guiding the elastic tensioner 20 along the membrane 11. The guide 25 is formed in this case by the holding unit 15, in particular by the casing 16. As shown in FIGS. 6b and 6c, the guide 25 extends along the membrane 11 in all spatial directions, whereby the elastic tensioner 20 also runs in all spatial directions. When the elastic tensioner 20 contracts, the membrane 11 is gathered in all spatial directions, i.e. in three dimensions. It is particularly preferred that the guide 25 extends as uniformly as possible in all spatial directions, so that the gathering of the membrane 11 also occurs as uniformly as possible.

To achieve effective gathering of the membrane 11, the guide, in particular the casing 16, runs in meandering paths 18, as shown in FIGS. 6b and 6c. The meandering paths 18 also run in all spatial directions to achieve uniform gathering of the membrane.

As shown in FIGS. 6a to 6c, the membrane 11 comprises a guide section 24 through which the guide 25 runs. In particular, the guide section 24 extends in the Z-direction from a first end 33 to a second end 34. The first end 33 of the guide section 24 faces the first end 29 of the bellows 10. The second end 34 of the guide section 24 faces the second end 30 of the bellows 10. The first end 33 of the guide section 24 is formed in particular adjacent to the first end 29 of the bellows 10. The second end 34 of the guide section 24 is formed in particular adjacent to the second end 30 of the bellows 10. The meandering paths 18 run back and forth between the first end 33 of the guide section 24 and the second end 34 of the guide section 24, whereby the guide 25, in particular the casing 16, extends in the Z-direction.

To achieve an extension of the guide 25 in the X and Y directions, the individual sub-sections 19 of the meandering paths 18 run in alternating curves 35. A single sub-section 19 of the meandering path 18 extends from the first end 33 to the second end 34 of the guide section 24. The alternating curves 35 cause the guide 25 to extend in the X and Y directions relative to the machine coordinate system.

In the present embodiment shown in FIGS. 6a to 6c, the sub-sections 19 of the meandering paths 18 of the guide 25 run obliquely on the outer surface of the membrane 11 between the first end 33 and the second end 34 of the guide section 24. In conjunction with the alternating curves 35 of the meandering paths 18, a staircase-like pattern is thus formed on the membrane 11, over which the guide 25, and thus also the elastic tensioner 20, in particular the rubber band 21, extends along the membrane 11. As this staircase-like pattern of the guide 25 surrounds the three-dimensional membrane 11, the guide 25 also extends in all spatial directions, whereby the gathering of the membrane 11 also takes place in all spatial directions.

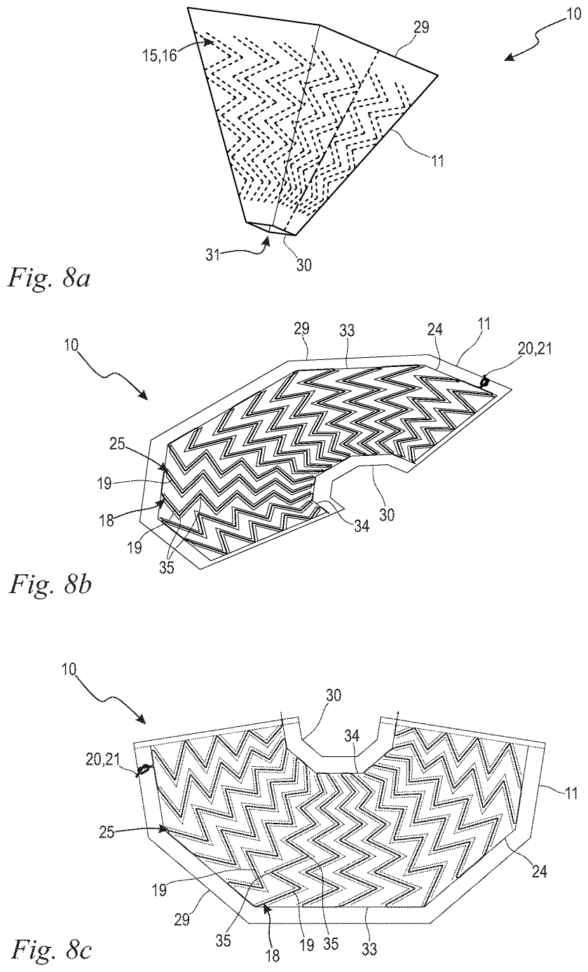

FIGS. 8a to 8c show a further embodiment of the bellows 10, which differs from the previously described embodiment only in the configuration of the guide 25. The meandering paths 18 run less obliquely across the outer surface of the membrane 11. The alternating curves 35 in each section 19 of the meandering path 18 are significantly tighter, thereby creating a kind of zigzag pattern on the membrane 11.

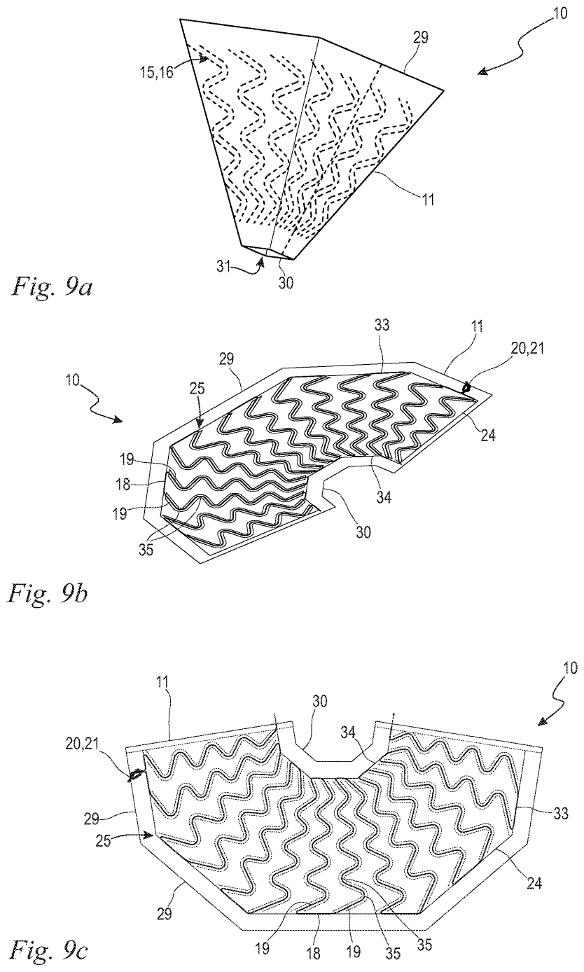

FIGS. 9a to 9b show a further embodiment of the bellows 10. This embodiment differs from the embodiment shown in FIGS. 8a to 8c in the configuration of the alternating curves 35. The alternating curves 35 shown in FIGS. 9a to 9c are less narrow than the alternating curves 35 shown in FIGS. 8a to 8c. Consequently, the alternating curves 35 form a serpentine pattern rather than a zigzag pattern for each section 19 of the meandering path 18.

Other embodiments of the guide 25 may also be appropriate, provided that the guide 25 extends in all spatial directions and effective gathering of the membrane 11 is ensured in all spatial directions.

As shown in FIG. 3, the bellows 10 preferably comprises a receptacle 14 for attaching the membrane 11 to the movable component, in this case to the spindle unit 4 of the machining apparatus 1. The receptacle 14 is arranged at the second end 30 of the membrane 11. In this case, the receptacle 14 is designed to be dimensionally stable. The receptacle 14 is, in this case, cup-shaped. The receptacle 14 is preferably made of a plastic material. The receptacle 14 has an opening 36, in particular at its base. The receptacle 14 is fitted onto the movable component via the opening 36. The movable component preferably has a shoulder 37 against which the cup base 38 rests. The receptacle 14 is preferably fixedly connected to the movable component via its cup base 38, in particular by means of a screw connection.

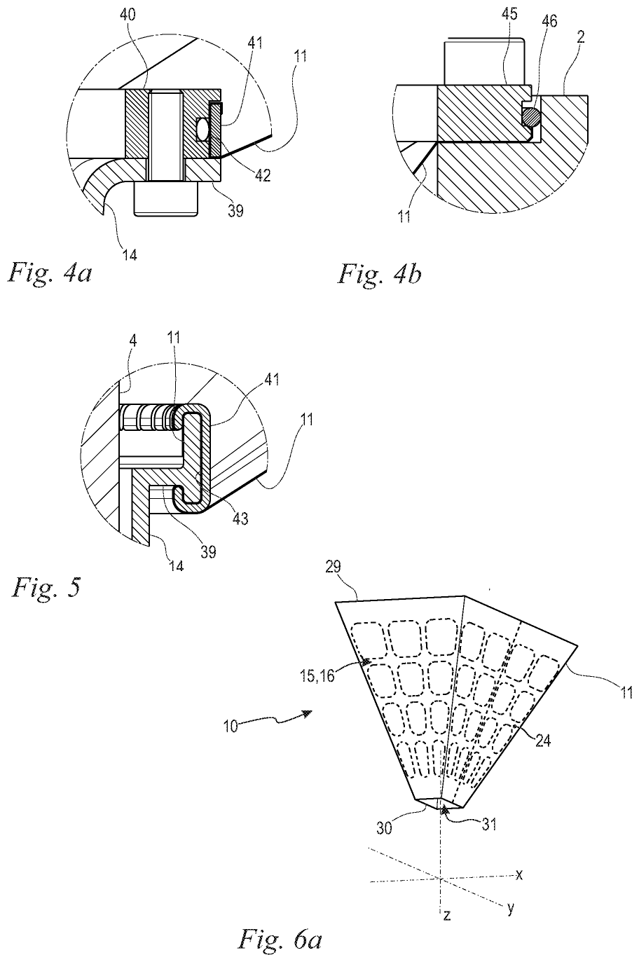

FIGS. 4a and 5 show two different embodiments of how the membrane 11 of the bellows 10 is secured to the receptacle 14. In the embodiment shown in FIG. 4a, the cup-shaped receptacle 14 is connected to a holding ring 40 via a cup rim 39. The membrane 11 is held in place on the holding ring 40, in particular by means of a clamping ring 41. Preferably, a seal 42 is provided circumferentially on the holding ring 40. The seal 42 is preferably designed as an O-ring. The seal 42 also contacts the membrane 11. This ensures that no chips, dust or liquid can pass between the holding ring 40 and the membrane 11. Furthermore, this improves the clamping action.

In the embodiment shown in FIG. 5, the receptacle 14 comprises a web 43 at its cup rim 39. The web 43 is specifically T-shaped. The clamping ring 41 is clipped onto the web 43. The membrane 11 is held between the clamping ring 41 and the web 43 of the receptacle 14. As the clamping ring 41 grips the web 43 at both of its T-shaped legs, sufficient sealing between the receptacle 14 and the membrane 11 is ensured. The clamping ring 41 is elastic. It may also be provided that a beading is provided at the second end 30 of the membrane 11, via which beading the membrane 11 is held in a form-fitting manner on the receptacle 14.

As shown in FIGS. 2 and 3, the bellows 10 is secured at its first end 29, in particular to a fixed part of the machining apparatus 1. In the present case, the machining apparatus 1 comprises a clamping frame 45 for this purpose. The clamping frame 45 may comprise one or more clamping strips. In the present case, the clamping frame 45 is formed from two clamping strips. The clamping strips are screwed to the housing 2 of the machining apparatus 1 via screw connections. As shown in FIG. 4a, the membrane 11 is held clamped between the clamping frame 45 and the housing 2. Preferably, a circumferential beading 46 is provided at the first end 29 of the membrane 11, in particular sewn in. This is held clamped between the clamping frame 45 and the housing 2, whereby it serves as a seal analogous to an O-ring. The beading 46 is preferably arranged in part within a groove in the clamping frame 45 and/or the housing 2, whereby the beading 46 itself is held in a form-fitting manner. As a result, the membrane 11 is securely attached to the housing 2 at its first end 29. Alternatively, the hem of the membrane 11 may be provided with ring eyelets or the like, so as to be fixed to the housing 2 by means of screws, hooks or the like.

What is claimed is:

1. A bellows (10) for separating two spaces in a machining apparatus (1), comprising:
a membrane (11);
an elastic tensioner (20) separate from the membrane (11); and
a receptacle (14) configured to attach the membrane (11) to a movable component of the machining apparatus (1),
wherein the membrane (11) is deformable in at least two directions,
wherein the elastic tensioner (20) is operatively connected to the membrane (11) such that the elastic tensioner (20) gathers the membrane (11).

2. The bellows according to claim 1,
wherein the membrane (11) comprises a first membrane layer (12), and
wherein the first membrane layer (12) consists of a textile sheet material or a film.

3. The bellows according to claim 2,
wherein the membrane (11) further comprises a second membrane layer (13), and
wherein the second membrane layer (13) consists of a second textile sheet material or a second film.

4. The bellows according to claim 3,
wherein the first membrane layer (12) and/or the second membrane layer (13) is shaped as a truncated pyramid or a truncated cone.

5. The bellows according to claim 3,
wherein the membrane (11) comprises a holding unit (15) configured to receive and retain the elastic tensioner (20) on the first membrane layer (12), the second membrane layer (13), or both.

6. The bellows according to claim 5,
wherein the holding unit (15) is a casing (16).

7. The bellows according to claim 6,
wherein the casing (16) is formed by a seam (17) between the first membrane layer (12) and the second membrane layer (13).

8. The bellows according to claim 6,
wherein the casing (16) has meandering paths (18).

9. The bellows according to claim 6,
wherein the elastic tensioner (20) is a rubber band (21), and
wherein the rubber band (21) is held so as to be slidable within the casing (16).

10. The bellows according to claim 9,
wherein the rubber band (21) comprises an elastic core (22) and a sheath (23) surrounding the elastic core (22),
wherein the sheath (23) is configured to provide overload protection for the elastic core (22) and is slidable over the holding unit (15), the first membrane layer (12), and/or the second membrane layer (13).

11. The bellows according to claim 1,
wherein the receptacle (14) of the bellows (10) is cup-shaped.

12. A machine (1), comprising:
a tool holder for holding a tool configured for additive or subtractive processing of a workpiece (50);
a drive chamber (28) comprising a drive unit for moving the tool holder or the tool;
a processing chamber (27) in which the workpiece (50) is processed; and
a bellows (10) separating the drive chamber (28) from the processing chamber (27),
wherein the bellows (10) comprises
a membrane (11);
an elastic tensioner (20) separate from the membrane (11); and
a receptacle (14) configured to attach the membrane (11) to a movable component of the machine (1),
the membrane (11) being deformable in at least two directions, and
the elastic tensioner (20) being operatively connected to the membrane (11) such that the elastic tensioner (20) gathers the membrane (11).
